(19) United States
(12) Patent Application Publication
(10) Pub. No.: US 2012/0097312 A1
(43) Pub. Date: Apr. 26, 2012

(54) REDUCED WEIGHT AIRCRAFT TIRE

(76) Inventors: Kiyoshi Ueyoko, Copley, OH (US); Badal Das, Strongsville, OH (US)

(21) Appl. No.: 12/910,161

(22) Filed: Oct. 22, 2010

(51) Int. Cl. B60C 9/02

(52) U.S. Cl. 152/552

(57) ABSTRACT

A pneumatic tire is disclosed having a carcass and a belt reinforcing structure, the carcass comprising at least two inner plies which are wound around a annular bead member from axially inside of the annular bead member toward axially outside thereof and extends radially outward towards the crown to form respective turnup portions; At least one of the inner plies does not wrap around the annular bead member and has a terminal end which has a radial location between a first plane and a second plane, wherein the first plane is tangent to the outer radial surface of the annular bead member and parallel to the tire axis of rotation, and the second plane is tangent to the inner radial surface of the annular bead member and parallel to the axis of rotation of the tire, the carcass further comprising at least two outer plies which extend radially inward from the crown and axially outward of the annular bead member and further extend axially outward and are wrapped around the bead terminating in endings.

### FIELD OF THE INVENTION

This invention relates to pneumatic tires having a carcass and a belt reinforcing structure, more particularly to high speed heavy load tires such as those used on aircraft.

### BACKGROUND OF THE INVENTION

The radial carcass reinforcements of aircraft tires generally comprise several plies of textile cords, which are anchored in each bead to at least one annular bead member generally formed having a single continuously wound bead wire. The reinforcing elements of these reinforcements are wound around said annular bead member from the inside to the outside, forming turn-ups, the respective ends of which are spaced radially from the axis of rotation of the tire. The severe conditions under which airplane tires are used are such that the life of the beads is short, particularly in the area of the turn-ups of the carcass reinforcement.

A substantial improvement in performance is obtained by the separating the carcass plies into two groups. The first group comprises the plies of the carcass reinforcement which are axially towards the inside in the region of the beads, these plies being then wound around a annular bead member in each bead from the inside to the outside of the tire. The second group is formed of at least one axially outer ply in the region of the beads, which ply is generally wound around the annular bead member from the outside to the inside of the tire.

The areas directly inward of the annular bead member and axially outward are respectively called the bead base and the bead flange areas. These areas are in direct contact with the rim and accordingly a tough durable rubber compound commonly referred to as a chafer is used in this area. The particular area of the tire located directly between the annular bead member and the rim bead seat experience very high loads. The use of round annular bead members and radial plies create a rocking action under taxiing and straight line driving on takeoffs that can cause the chafer to crack.

It is an object of the present invention to provide a lightweight efficient tire structure having superb durability and not prone to bead chafer cracks. It is a further object of the present invention to provide an improved bead structure wherein the use of inside turn-up plies and outside turndown plies is optimized. Thus an improved aircraft tire is needed, which is capable of meeting high speed, high load and with reduced weight.

### Definitions

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Cord” means one of the reinforcement strands of which the plies in the tire are comprised.

“Equatorial plane (EP)” means the plane perpendicular to the tire's axis of rotation and passing through the center of its tread.

“Ply” means a continuous layer of rubber-coated parallel cords.

“Radial” and “radially” mean directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

“Zigzag belt reinforcing structure” means at least two layers of cords or a ribbon of parallel cords having 1 to 20 cords in each ribbon and laid up in an alternating pattern extending at an angle between 5° and 30° between lateral edges of the belt layers.

### BRIEF DESCRIPTION OF THE DRAWINGS

The invention will be described by way of example and with reference to the accompanying drawings in which:

FIG. 1 is a schematic cross-sectional view of a first embodiment of a tire according to the invention; and

FIG. 2 is a second embodiment of the bead area of the tire.

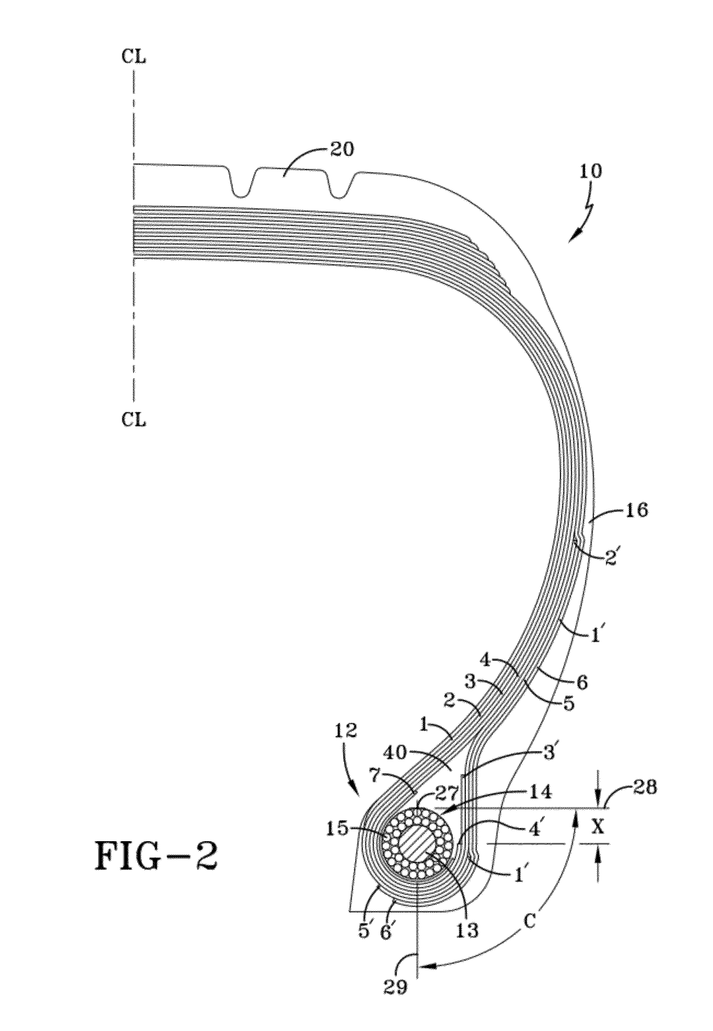

### DETAILED DESCRIPTION OF THE INVENTION

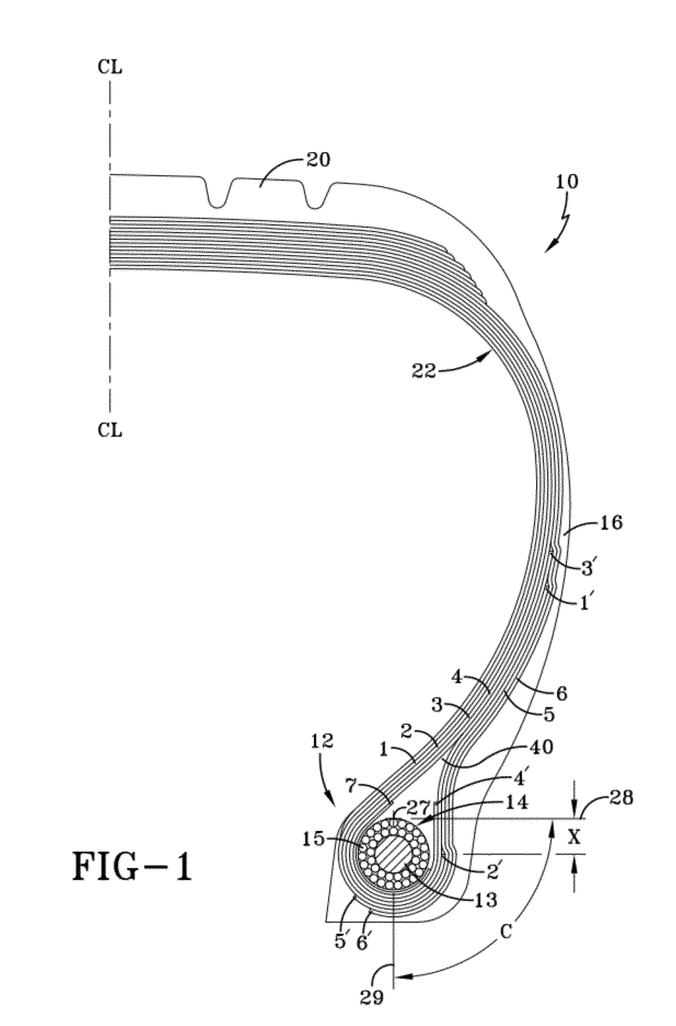

FIG. 1 illustrates a cross-sectional view of one half of a radial aircraft tire 10 of the present invention. The tire is symmetrical about the mid-circumferential plane so that only one half is illustrated. As shown, the aircraft tire comprises a pair of bead portions 12 each containing an annular bead member 14 embedded therein. One example of an annular bead member suitable for use in an aircraft tire is shown in U.S. Pat. No. 6,571,847. The annular bead member 14 preferably has an aluminum, aluminum alloy or other light weight alloy in the center portion 13 surrounded by a plurality of steel sheath wires 15. A person skilled in the art may appreciate that other annular bead members may also be utilized. Radially outward of the bead is an apex 40.

The aircraft tire further comprises a sidewall portion 16 extending substantially outward from each of the bead portions 12 in the radial direction of the tire, and a tread portion 20 extending between the radially outer ends of the sidewall portions 16. Furthermore, the tire 10 is reinforced with a carcass 22 toroidally extending from one of the bead portions 12 to the other bead portion 12. The carcass 22 is comprised of an innerliner and at least two inner carcass plies 1,2,3,4 and outer carcass plies 5,6, preferably oriented in the radial direction. Among these carcass plies, typically four inner plies 1,2,3,4 extend radially inward from the crown towards the bead area 12. The inner plies 1,2,3,4 are wound around the annular bead member 14 from axially inside of the annular bead member toward axially outside thereof and extends radially outward towards the crown to form respective turnup portions 1′, 2′, 3′, 4′. At least one of the plies, e.g., 1, has a terminal end 1′ which is located within a zone denoted as “C.” Zone C is defined by a first plane 28 that is tangent to the outer radial surface of the annular bead member at its radially outermost point 27, and wherein the first plane 28 is parallel to the tire axis of rotation. Zone C is further defined by a second plane 29 that extends through the center point of the annular bead member and wherein the second plane 29 is perpendicular to the first plane or axial direction (i.e., axis of rotation of the tire). Zone C is further defined by the intersection of the first plane 28 and the second plane 29 and the quadrant that is axially outward of the second plane 29 and radially inward of the first plane 28.

Preferably, the terminal end 1′ of the innermost ply 1 is located within Zone C and at a radial distance X from the first plane 28 in the range of about 1 mm to about 10 mm and more preferably in the range of about 1 mm to about 5 mm. Two of the inner plies may have a terminal end located within Zone C. However no more than 50% of the total inner plies may have a terminal end located within Zone C. It is preferred that at least two of the innermost plies have a terminal end which are radially outward of the apex.

The carcass further comprises at least two outer plies 5,6 which extend radially inward from the crown and are axially outward of the annular bead member 14 along the outside of the turnup portion of the inner carcass plies 24. The two outer carcass plies 5,6 extend down from the crown and further extend axially outward and are wrapped around the bead terminating in endings 5′, 6′, respectively. Preferably, one of the endings 5′, 6′ overlap with the one or more inner plies which has a terminal end having a radial location in Zone C. Preferably, two of the endings 5′, 6′ overlap with the one or more inner plies which has a terminal end in Zone C.

Each of these carcass plies 1-6 may comprise any suitable cord, typically nylon cords such as nylon-6,6 cords extending substantially perpendicular to an equatorial plane EP of the tire (i.e., extending in the radial direction of the tire). Preferably the nylon cords have an 1890 denier/2/2 or 1890 denier/3 construction. One or more of the carcass plies 24, 26 may also comprise an aramid and nylon cord structure, for example, a hybrid cord, a high energy cord or a merged cord. The carcass ply may also be polyketone. Examples of suitable cords are described in U.S. Pat. No. 4,893,665, U.S. Pat. No. 4,155,394 or U.S. Pat. No. 6,799,618.

The aircraft tire 10 further comprises a belt package 40 arranged between the carcass 22 and the tread rubber 20. The belt package 40 as shown comprises a first belt layer 50 located adjacent the carcass. The first belt layer 50 is preferably formed of cords having an angle of 5 degrees or less with respect to the mid-circumferential plane. Preferably, the first belt layer 50 is formed of a rubberized strip of two or more cords made by spirally or helically winding the cords at an angle of plus or minus 5 degrees or less relative to the circumferential direction. The first belt layer 50 is the narrowest belt structure of the belt package 40, and has a width in the range of about 13% to about 100% of the rim width (width between flanges).

The belt package 40 further comprises a second belt layer 60 located radially outward of the first belt layer 50. The second belt layer 60 is preferably formed of cords having an angle of 5 degrees or less with respect to the mid-circumferential plane. Preferably, the second belt layer 60 is formed of a rubberized strip 43 of two or more cords made by spirally or helically winding the cords at an angle of plus or minus 5 degrees or less relative to the circumferential direction. The second belt layer has a width in the range of about 101% to about 120% of the rim width, and has a width greater than the first belt layer 50. More preferably, the second belt layer 60 is the widest belt layer of the belt package 40.

The belt package 40 further comprises at least one zigzag belt reinforcing structure 70. The zigzag belt reinforcing structure 70 is comprised of two layers of cord interwoven together. It is preferred that the zigzag belt structure 70 is the most radially outward belt structure of the belt package 40. It is additionally preferred that there is only one zigzag belt structure. The zigzag belt structure 70 is preferably wider than the first belt structure, and more preferably is wider than the first belt structure but has a width less than the second belt structure 60.

In any of the above described embodiments, the cords are preferably continuously wound from one belt structure to the next.

The cords of any of the above described carcass, spiral or zigzag belt layers described above may be nylon, nylon 6,6, aramid, or combinations thereof, including merged, hybrid, high energy constructions known to those skilled in the art. One example of a suitable cord construction for the belt cords, carcass cords (or both), may comprise a composite of aramid and nylon, containing two cords of a polyamide (aramid) with construction of 3300 dtex with a 6.7 twist, and one nylon or nylon 6/6 cord having a construction of 1880 dtex, with a 4.5 twist. The overall merged cable twist is 6.7. The composite cords may have an elongation at break greater than 11% and a tensile strength greater than 900 newtons. Optionally, the original linear density may be greater than 8500 dtex. Elongation, break, linear density and tensile strength are determined from cord samples taken after being dipped but prior to vulcanization of the tire.

Variations of the present invention are possible in light of the description as provided herein. While certain representative embodiments and details have been shown for the purpose of illustrating the subject inventions, it will be apparent to those skilled in the art that various changes and modifications can be made without departing from the scope of the subject inventions.

What is claimed is:

1. A pneumatic tire having a carcass and a belt reinforcing structure, the carcass comprising at least two inner plies which are wound around an annular bead member from axially inside of the annular bead member toward axially outside thereof and extends radially outward towards the crown to form respective turnup portions; At least one of the inner plies does not wrap around the annular bead member and has a terminal end which has a radial location in a zone defined by a first plane and a second plane, wherein the first plane is tangent to the outer radial surface of the annular bead member and parallel to the tire axis of rotation, and the second plane is perpendicular to the first plane and extends through the center of the annular bead member, wherein said zone is radially inward of the first plane and axially outward of the second plane.

2. The tire of claim 1 wherein the carcass further comprises at least two outer plies which extend radially inward from the crown and axially outward of the annular bead member and further extend axially outward and are wrapped around the bead.

3. The tire of claim 1 wherein at least one of the outer carcass plies has an ending that overlaps with the terminal end of the inner carcass ply in said zone.

4. The tire of claim 1 wherein the axially outermost inner ply does not wrap around the annular bead member and has a terminal end located in said zone.

5. The tire of claim 1 wherein the axially innermost inner ply does not wrap around the the annular bead member and has a terminal end located in said zone.

6. The tire of claim 1 wherein at least one of the inner plies has a turnup end located between the first plane and the tip of the apex.

7. The tire of claim 1 wherein no more than 50% of the inner plies do not wrap around the bead.

8. The tire of claim 1 wherein no more than 50% of the inner plies have a terminal end located in said zone.

9. The pneumatic tire of claim 1 wherein the radial carcass ply cord fiber is made of a nylon and aramid blend.

10. The pneumatic tire of claim 1 wherein the radial carcass ply cord fiber is aramid.

11. The pneumatic tire of claim 1 wherein the radial carcass ply cord fiber is polyketone.

12. The pneumatic tire of claim 1 wherein the radial carcass ply cord fiber is nylon.
